(19) United States
(12) Patent Application Publication
(10) Pub. No.: US 2007/0038891 A1
(43) Pub. Date: Feb. 15, 2007

(54) Hardware checkpointing system

(75) Inventor: Simon P. Graham, Bolton, MA (US)

Correspondence Address: KIRKPATRICK & LOCKHART NICHOLSON GRAHAM LLP, One Lincoln Street, BOSTON, MA, 02111-2950, US

(73) Assignee: Stratus Technologies Bermuda Ltd., Hamilton (BM)

(21) Appl. No.: 11/202,526

(22) Filed: Aug. 12, 2005

(51) Int. Cl. G06F 11/00

(52) U.S. Cl. 714/28

(57) ABSTRACT

A method and a system for recovering a computing system's hardware state. In one embodiment the method includes simulating a removal of a hardware device from a bus of the computing system, simulating the replacement of the hardware device onto the bus and executing a configuration program for the computing system. In another embodiment the removal of the hardware device from the bus is simulated following a detection of a fault in the computing system. In another embodiment the simulating of the removal of the hardware device from the bus includes modifying a list of hardware devices connected to the bus by removing the hardware device from the list.

### FIELD OF INVENTION

The invention relates to computer systems and more specifically to checkpointing of computer systems.

### BACKGROUND OF THE INVENTION

Most faults encountered in a computer system are transient or intermittent in nature, exhibiting themselves as momentary glitches. However, since transient and intermittent faults can, like permanent faults, corrupt data that is being manipulated at the time of the fault, it is necessary to record periodically a recent state of the computer system to which the computer system can be restored following the fault. Such periodic a recordation of recent computer states is termed “checkpointing”.

By enabling a computer system to revert to a known state following a system fault, checkpointing makes such a system fault tolerant. In a fault tolerant system, checkpointing involves periodically recording the state of the computer system, in its entirety, at time intervals designated as checkpoints. If a fault is detected at the computer system, recovery may then be had by diagnosing and circumventing a malfunctioning unit, returning the state of the computer system to the last checkpointed state before the fault occurred, and resuming normal operations from that state.

Advantageously, if the state of the computer system is checkpointed several times each second, the computer system may be recovered (or rolled back) to its last checkpointed state in a fashion that is generally transparent to a user. Moreover, if the recovery process is handled properly, all applications can be resumed from their last checkpointed state with no loss of continuity and no contamination of data.

However, checkpointing the state of modern computer systems is computationally intensive and time consuming. Therefore, it is advantageous to not save the state of any device that either has no state or which has state that need not be saved. For example, although it is imperative to save the state of the processor in order to resume calculations after recovering from a fault, it is not necessary to save the state of the mouse or keyboard. This is because such devices need only be reset or set to a known state in order to continue operation of the system after system recovery. That is, the mouse cursor position or last button pressed is irrelevant for the continued operation of the system and need not be saved.

The present invention addresses a way of restoring devices to a known state when their state need not be retained.

### SUMMARY OF THE INVENTION

The invention relates to a method and a system for recovering a computing system's hardware state. In one embodiment the method includes simulating a removal of a hardware device from a bus of the computing system, simulating the replacement of the hardware device onto the bus and executing a configuration program for the computing system. In another embodiment the removal of the hardware device from the bus is simulated following a detection of a fault at the computing system. In yet another embodiment the simulating of the removal of the hardware device from the bus includes clearing bits in a command register of the hardware device. In another embodiment the simulating of the removal of the hardware device from the bus includes modifying a list of hardware devices connected to the bus by removing the hardware device from the list.

In one embodiment upon the execution of the configuration program, the configuration program deems the hardware device removed from the bus. In another embodiment the hardware device is deemed removed from the bus based upon a comparison between the modified list of hardware devices connected to the bus and a master list.

In another embodiment the simulating of the addition of the hardware device to the bus comprises re-initializing the hardware device. In yet another embodiment, re-initializing the hardware device comprises re-setting bits in a command register of the hardware device.

In one embodiment a system for recovering a computing system's hardware state includes a plurality of hardware devices connected to a bus of the computing system, a recovery program configured to simulate a removal of a hardware device from the bus and a configuration program configured to determine, upon simulation of the removal of the hardware device from the bus, that the hardware device has been removed from the bus. In another embodiment the recovery program is further configured to simulate the removal of the hardware device from the bus following a detection of a fault at the computing system. In yet another embodiment the recovery program, in simulating the removal of the hardware device from the bus, is configured to clear bits in a command register of the first hardware device.

In yet another embodiment the system further includes a filter configured to modify a list of hardware devices connected to the bus. In still yet another embodiment the recovery program, in simulating the removal of the hardware device from the bus, is configured to instruct the filter to modify the list of hardware devices connected to the bus by removing the hardware device from the list. In another embodiment the configuration program deems the hardware device removed from the bus based upon a comparison between the modified list of hardware devices connected to the bus and a master list.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1 is a schematic diagram of a system implementing an embodiment of the invention; and

FIG. 2 is a block diagram of the behavior of the system of FIG. 1 following a system failure.

### DESCRIPTION OF THE PREFERRED EMBODIMENT

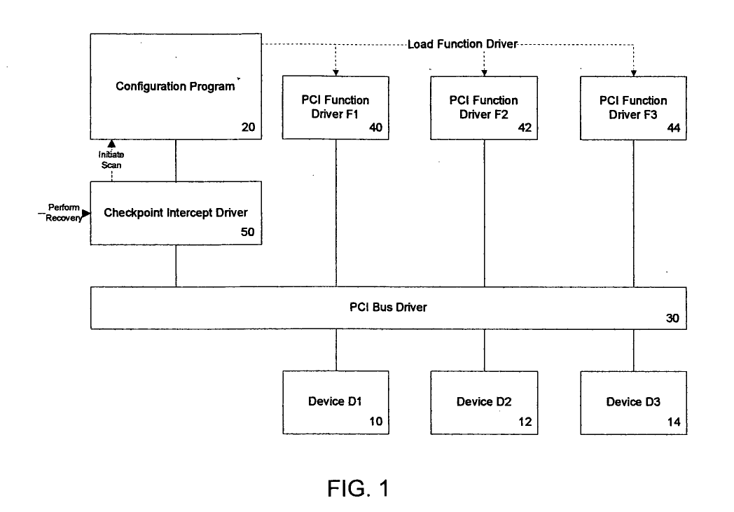

In brief overview and referring to FIG. 1, in a typical computer system, when a new device (10) is installed in the computer system, a system interrupt is generated. A configuration manager 20 issues a query to a PCI bus driver 30 requesting a list of devices then present on the bus. The purpose of the configuration manager 20 is to permit the automatic loading of device drivers when a new device is placed onto the bus thereby allowing the user to use the device without any other intervention by the user. The PCI bus driver 30 then returns the list of devices on the PCI bus to the configuration manager 20.

For example, referring to FIG. 1, assume that (D1) 10 and (D3) 14 are devices present on the computer bus. For the purpose of this example, consider that device (D2) 12 is not initially present on the bus. Once the device (D2) 12 is installed on the bus an interrupt is generated and the configuration manager 20 requests that the PCI bus driver 30 provide a list of devices then present on the bus. The configuration manager 20 compares the list returned by the PCI bus driver 30 against a list of devices (D1) 10 and (D3) 14 previously known to be on the bus. The configuration manager 20 then determines which device (D2) 12 has been added to the bus. The configuration manager 20 then makes a request to load the PCI function driver corresponding to new device (D2) 12.

Referring again to FIG. 1, in one embodiment of the present invention, a checkpoint intercept driver 50 is inserted between the configuration manager 20 and the PCI bus driver 30. This checkpoint intercept driver facilitates the simulated removal of devices from the bus without requiring their actual physical removal. During normal operation of the system the checkpoint intercept driver 50 is completely passive.

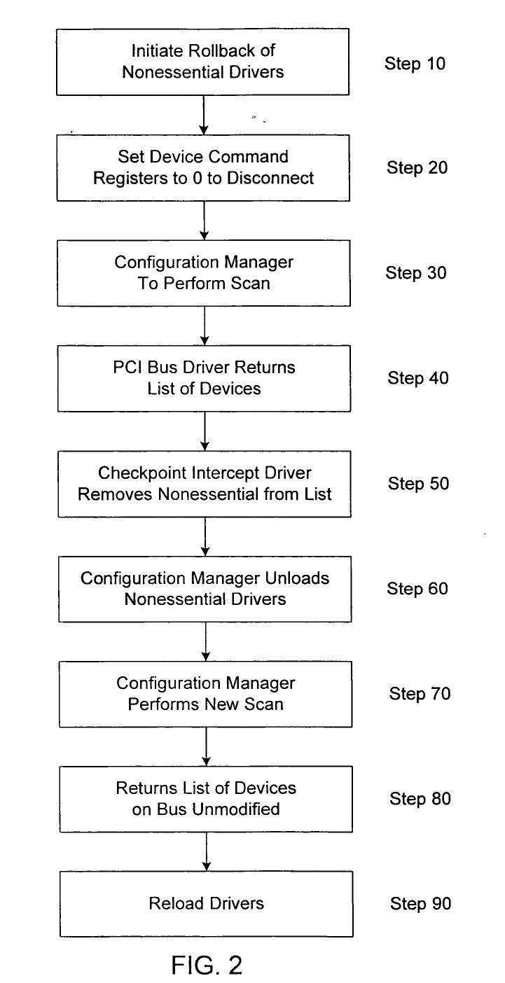

However, referring also to FIG. 2, following a system failure, in order to rollback (Step 10) the non-critical devices, the following steps are taken by the checkpoint intercept driver 50. First, the PCI command registers for all devices not configured as essential (including, for example, USB controllers to which the system keyboard and mouse are attached) are reset to zero (Step 20) to disconnect the devices from the PCI bus as defined in the PCI local bus specification. Next the configuration manager 40 is instructed by the checkpoint intercept driver 50 to perform a scan (Step 30) of the system by way of the same mechanism used when a device is physically removed from or added to the system. When the configuration manager 40 requests the list of PCI devices from the PCI Bus Driver 30 (Step 40), the checkpoint intercept driver 50 removes (Step 50) from the returned list all devices which have not been configured as essential. This causes the configuration manager 20 to unload and remove (Step 60) the PCI function drivers 40 for the non-essential devices.

Once this is complete, the configuration manager 40 is instructed to perform a second scan of the system (Step 70). In this case, the checkpoint intercept driver 50 leaves the returned list of devices unchanged (Step 80). This causes the configuration manager 40 to reload the drivers for the non-essential devices (Step 90). The PCI command registers are not modified in this second pass because they are set as part of the normal process of bringing a new device on line.

The foregoing description has been limited to a few specific embodiments of the invention. It will be apparent, however, that variations and modifications can be made to the invention, with the attainment of some or all of the advantages of the invention. It is therefore the intent of the inventor to be limited only by the scope of the appended claims.

What is claimed is:

1. A method for recovering a computing system's hardware state, the method comprising:
simulating a removal of a hardware device from a bus of the computing system;
simulating a replacement of the hardware device onto the bus of the computer system; and
executing a configuration program for the computing system.

2. The method of claim 1, wherein the removal of the hardware device from the bus is simulated following a detection of a fault at the computing system.

3. The method of claim 1, wherein simulating the removal of the hardware device from the bus comprises clearing bits in a command register of the hardware device.

4. The method of claim 1, wherein simulating the removal of the hardware device from the bus comprises modifying a list of hardware devices connected to the bus by removing the hardware device from the list.

5. The method of claim 4, wherein, upon the first execution of the configuration program, the configuration program deems the hardware device removed from the bus.

6. The method of claim 5, wherein the hardware device is deemed removed from the bus based upon a comparison between the modified list of hardware devices connected to the bus and a master list.

7. The method of claim 1 further comprising simulating an addition of the hardware device to the bus.

8. The method of claim 7, wherein simulating the addition of the hardware device to the bus comprises re-initializing the hardware device.

9. The method of claim 8, wherein re-initializing the hardware device comprises re-setting bits in a command register of the hardware device.

10. The method of claim 7 further comprising executing the configuration program for the computing system a second time.

11. The method of claim 10, wherein simulating the addition of the hardware device to the bus comprises passing a list of hardware devices connected to the bus to the configuration program in an unmodified state.

12. The method of claim 11, wherein, upon the second execution of the configuration program, the configuration program deems the hardware device added to the bus.

13. The method of claim 12, wherein the hardware device is deemed added to the bus based upon a comparison between the unmodified list of hardware devices connected to the bus and a master list.

14. The method of claim 10, wherein, following the second execution of the configuration program, the computing system reverts to a checkpointed state.

15. A sub-system for recovering a computing system's hardware state, the sub-system comprising:
a plurality of hardware devices connected to a bus of the computing system;
a recovery program configured to simulate a removal of a hardware device from the bus; and
a configuration program configured to determine, upon simulation of the removal of the hardware device from the bus, that the hardware device has been removed from the bus.

16. The sub-system of claim 15, wherein the recovery program is further configured to simulate the removal of the hardware device from the bus following a detection of a fault at the computing system.

17. The sub-system of claim 15, wherein the recovery program, in simulating the removal of the hardware device from the bus, is configured to clear bits in a command register of the hardware device.

18. The sub-system of claim 15, wherein the configuration program deems the hardware device removed from the bus based upon a comparison between the modified list of hardware devices connected to the bus and a master list.

19. The sub-system of claim 15, wherein the recovery program is further configured to simulate an addition of the hardware device to the bus.

20. The sub-system of claim 15, wherein the recovery program, in simulating the addition of the hardware device to the bus, is configured to re-initialize the first hardware device.

21. The sub-system of claim 20, wherein the recovery program, in re-initializing the hardware device, is configured to re-set bits in a command register of the first hardware device.

22. The sub-system of claim 20, wherein the configuration program is further configured to determine, upon simulation of the addition of the hardware device to the bus, that the hardware device has been added to the bus.

23. The sub-system of claim 22, wherein the configuration program deems the hardware device added to the bus based upon a comparison between the unmodified list of hardware devices connected to the bus and a previous list.
